(19) United States
(12) Patent Application Publication
(10) Pub. No.: US 2009/0100887 A1
(43) Pub. Date: Apr. 23, 2009

(54) Article of manufacture for quickly and efficiently locking and securing the security doors of a building

(76) Inventors: Gabor Hajzer, Sandy Hook, CT (US); Michael Hajzer, Sandy Hook, CT (US)

Correspondence Address: Michael Hajzer, 26 Berkshire road, Sandy Hook, CT, 06482, US

(21) Appl. No.: 11/975,601

(22) Filed: Oct. 20, 2007

(51) Int. Cl. E05B 35/00

(52) U.S. Cl. 70/344

(57) ABSTRACT

An article of manufacture for quickly and efficiently locking and securing the security doors of a building with A single Allen key piece, A housing for the Allen key piece, and diamond knurling on the housing. In a preferred embodiment, the Allen key is fitted into the housing for proper use.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of appliances and more specifically to an article of manufacture for quickly and efficiently locking and securing the security doors of a building.

The invention disclosed eliminates the need for a standard allen key which was used to lock certain security doors. This process was very slow and cumbersome. It was nowhere near efficient to a “standard key”. Newer technology produced in some of these security doors eliminates the need for a traditional key. Instead, the manufacturer simply included, in this case, an Allen head fitting. At the moment, the only tool capable of locking up these doors is an ordinary Allen key. Usually found in general stores, Allen keys are long, and sometimes quite expensive. Their “L” shaped design makes it a hassle to carry in terms of portability. Additionally, it is very easy to misplace them around a busy working area because of it's black color and minimalistic features.

### BRIEF SUMMARY OF THE INVENTION

The primary object of the invention is To quickly and efficiently lock and secure the security doors of a building perimeter.

Another object of the invention is To provide an effortless process of locking security doors.

Another object of the invention is To replace the slow and clumsy operation of a standard Allen key.

A still further object of the invention is to make it portable enough to carry on a daily basis.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an article of manufacture for quickly and efficiently locking and securing the security doors of a building comprising: A single Hex key piece (Reference 10), A housing for the Allen key piece with diamond knurling (Reference 11), and a detachable key ring (Reference 12). Said diamond knurling on said housing provides grip for operation.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. <1> is an elevational view of the invention. (Consult following page)

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

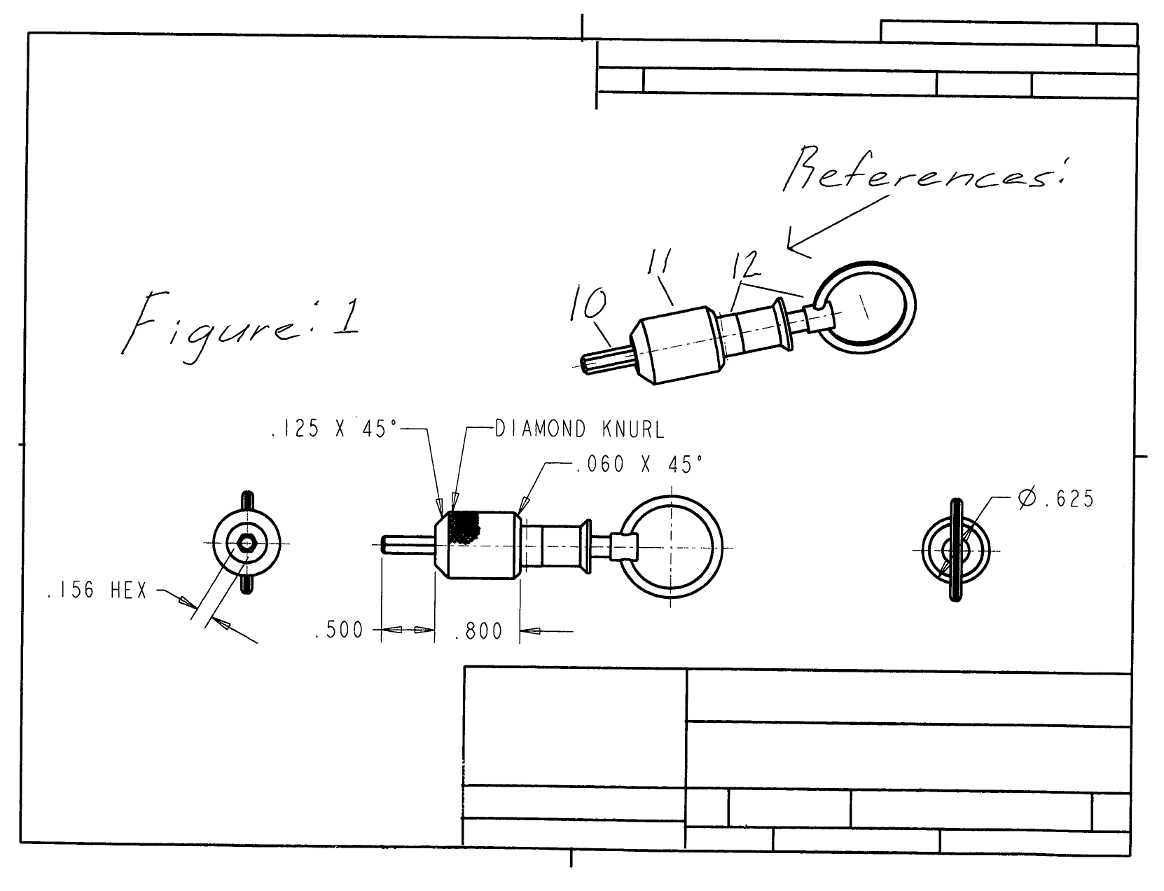

The Allen key has been used for decades. The tool is a very simple appliance, but we were still able to maintain that simplicity as we included it in the disclosed invention. This invention is an article of manufacture for quickly and efficiently locking the security doors of a building perimeter. In reference 10 of FIG. 1, the Allen key, 0.5 inches in length, is fitted into an aluminum housing at reference 11. This aluminum housing is specially modified with a diamond knurling, which provides grip for the hand. It also allows for greater amounts of applied torque, while maintaining portability and weightlessness. At reference 12, a pull apart key ring fits into the aluminum housing, which houses the key ring's counterpart. This implementation of a simple tool allows for even greater portability and convenience. In a preferred embodiment, the user holds the invention in the hands and applies usage similar to that of a screw driver.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An article of manufacture for quickly and efficiently locking and securing the security doors of a building comprising:
A single Allen key piece;
A housing for the Allen key piece;
Diamond knurling on the housing; and

2. The invention in claim 1 wherein said single Allen piece fits into said housing for operation

3. The invention in claim 2 comprising of a housing made of aluminum

4. The invention in claim 2 further comprising of an aluminum housing with diamond knurling

5. The invention in claim 1 wherein said single Allen piece is 0.5 inches

6. The invention in claim 2 wherein said housing can accommodate different diameters of Allen key pieces
